(19) United States
(12) Patent Application Publication
(10) Pub. No.: US 2014/0313954 A1
(43) Pub. Date: Oct. 23, 2014

(54) APPARATUS AND METHOD FOR SAVING ENERGY IN A COMMUNICATION SYSTEM SUPPORTING MULTIPLE INTERFACES

(71) Applicants: Jun Kyun Choi, Yuseong-gu Daejeon (KR); Joo Hyung Lee, Yuseong-gu Daejeon (KR); Younf Mi Lim, Yuseong-gu Daejeon (KR)

(72) Inventors: Jun Kyun Choi, Yuseong-gu Daejeon (KR); Joo Hyung Lee, Yuseong-gu Daejeon (KR); Younf Mi Lim, Yuseong-gu Daejeon (KR)

(73) Assignee: Intellectual Discovery Co, Ltd., Gangnam-gu, Seoul (KR)

(21) Appl. No.: 14/000,764

(22) PCT Filed: Feb. 21, 2012
(86) PCT No.: PCT/KR2012/001307

§ 371 Date: Sep. 4, 2013

(30) Foreign Application Priority Data
Feb. 21, 2011 (KR) 10-2011-0014981

(51) Int. Cl. H04W 52/02

(52) U.S. Cl. CPC H04W 52/0251
USPC 370/311

(57) ABSTRACT

The present invention relates to an apparatus and method for saving energy in a communication system supporting multiple interfaces. The apparatus for saving energy in a communication system supporting multiple interfaces based on a network, comprises: a profile database maintaining profile information related to an amount of power consumption by each interface; an energy determination unit determining an amount of energy consumption expected when downloading data according to the size of the data to be downloaded, and determining an amount of overload energy expected when changing a state mode related to the existence of traffic by using the profile information by each interface; and a system control unit selecting at least one interface for downloading data according to the amount of energy consumption and an amount of overload energy.

### TECHNICAL FIELD

The present invention relates to an energy saving apparatus and method that may optimize battery consumption in a communication system supporting multiple interfaces.

### BACKGROUND ART

Most terminals capable of wireless communication are designed to be able to access heterogeneous networks. In particular, a terminal supporting multiple interfaces may access multiple networks simultaneously and obtain a gain that maximizes a characteristic of each network. Research has been conducted on technologies for bandwidth aggregation through distribution of high capacity traffic through multiple interfaces when multiple networks are supported simultaneously. For example, a cellular phone terminal supported by a third generation (3G) network and a wireless-fidelity (Wi-Fi) network may download contents simultaneously, through simultaneous use of the 3D network and the Wi-Fi network.

Although a terminal supporting multiple interfaces has advantages in terms of a maximized download speed and a reduced transmission time, the terminal has disadvantages of an increase in battery consumption due to concurrent access to the multiple networks. However, technologies related to multiple interfaces researched to date have focused on throughput maximization and a quality of service (QoS) guarantee of conventional bandwidth aggregation, irrespective of battery consumption of a terminal. In particular, research is being conducted in an effort to increase an energy efficiency of a network. However, technologies related to a battery of a terminal are advancing at a slow pace. Since a demand for high capacity contents is increasing gradually, whereas a lifespan of a battery is increasing relatively slowly, a user may want an increase in throughput, and to receive a streaming service for a longer time.

Accordingly, there is a demand for an interface selection technology that may optimize battery consumption and guarantee a proper QoS in a terminal supporting multiple interfaces.

### DISCLOSURE OF INVENTION

### Technical Goals

An aspect of the present invention provides technologies for selecting an interface with a least battery consumption, and technologies for bandwidth aggregation by distributing traffic based on a proper data rate per interface, in order to optimize battery consumption of a communication system while guaranteeing a proper quality of service (QoS) when data is downloaded.

In particular, an apparatus and method for saving energy in a communication system that may distribute traffic based on a proper data rate, by selecting an optimal interface in view of an amount of the traffic and a state of energy of the interface.

### Technical Solutions

According to an aspect of the present invention, there is provided an apparatus for saving energy in a communication system supporting network-based multiple interfaces, the apparatus including a profile database to maintain profile information related to an amount of power to be consumed for each interface, an energy determiner to determine, for each interface, an amount of overload energy expected to occur when a state mode associated with a presence and absence of traffic is switched, and an amount of energy expected to be consumed for downloading data, based on a size of the data to be downloaded using the profile information, and a system controller to select at least one interface to be used for downloading the data, based on the amount of overload energy and the amount of energy to be consumed.

The system controller may select the at least one interface according to a priority determined based on a quality of service (QoS) defined in the communication system, from interfaces, each having a total amount of energy less than or equal to a predetermined value. Here, the total amount of energy may be obtained by adding the amount of overload energy to the amount of energy to be consumed.

The energy determiner may calculate, for each interface, a download time expected for downloading the data, and the system controller may select an interface having the expected download time less than or equal to a predetermined amount of time, from interfaces, each having a total amount of energy less than or equal to a predetermined value. Here, the total amount of energy may be obtained by adding the amount of overload energy to the amount of energy to be consumed.

The energy determiner may calculate, for each interface, a download speed expected for downloading the data, and the system controller may select an interface having the expected download speed greater than or equal to a predetermined speed, from interfaces, each having a total amount of energy less than or equal to a predetermined value. Here, the total amount of energy may be obtained by adding the amount of overload energy to the amount of energy to be consumed.

The energy determiner may calculate, for each interface, a download speed expected for downloading the data, and the system controller may select an interface having the expected download speed greater than or equal to a predetermined value, from interfaces, each having a total amount of energy less than or equal to a predetermined value, when the size of the data is less than a predetermined size. Here, the total amount of energy may be obtained by adding the amount of overload energy to the amount of energy to be consumed.

The energy determiner may calculate, for each interface, a download time expected for downloading the data, and the system controller may select an interface having the expected download time less than or equal to a predetermined amount of time, from interfaces, each having a total amount of energy less than or equal to a predetermined value, when the size of the data is greater than or equal to the predetermined size. Here, the total amount of energy may be obtained by adding the amount of overload energy to the amount of energy to be consumed.

The system controller may distribute a data rate for the downloading with respect to the at least one interface.

According to another aspect of the present invention, there is also provided a method of saving energy in a communication system supporting network-based multiple interfaces, the method including maintaining profile information related to an amount of power to be consumed for each interface, determining, for each interface, an amount of overload energy expected to occur when a state mode associated with a presence and absence of traffic is switched, and an amount of energy expected to be consumed for downloading data, based on a size of the data to be downloaded using the profile information, and selecting at least one interface to be used for downloading the data, based on the amount of overload energy and the amount of energy to be consumed.

### Advantageous Effects

An amount of energy consumed by a communication system may be saved effectively, by selecting an interface that may optimize battery consumption of a terminal when data is downloaded while guaranteeing a proper quality of service (QoS) through multiple interfaces, and distributing a data rate.

A data rate may be assigned through a combination of optimal interfaces within a range satisfying a proper QoS, in view of an amount of energy to be consumed for each interface when a downloading service is provided, and a current on/off state of an interface.

Accordingly, energy-efficient resource distribution technologies satisfying a demand for an increase in a lifespan of a battery of a terminal, and a demand for an increase in a throughput and a QoS of bandwidth aggregation may be provided.

### BRIEF DESCRIPTION OF DRAWINGS

FIG. 1 is a diagram illustrating an apparatus for saving energy in a communication system supporting multiple interfaces according to an embodiment of the present invention.

FIG. 2 is a block diagram illustrating a configuration of an energy saving apparatus for assigning a data rate by combining optimal interfaces in view of a size of data and a state of energy of an interface according to an embodiment of the present invention.

FIG. 3 is a table illustrating references for selecting an interface to optimize energy consumption according to an embodiment of the present invention.

FIG. 4 is a flowchart illustrating an energy saving method for assigning a data rate by combining optimal interfaces in view of a size of data and a state of energy of an interface according to an embodiment of the present invention.

FIG. 5 is a flowchart illustrating an example of an operation of selecting an optimal interface within a range satisfying a proper quality of service (QoS) according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

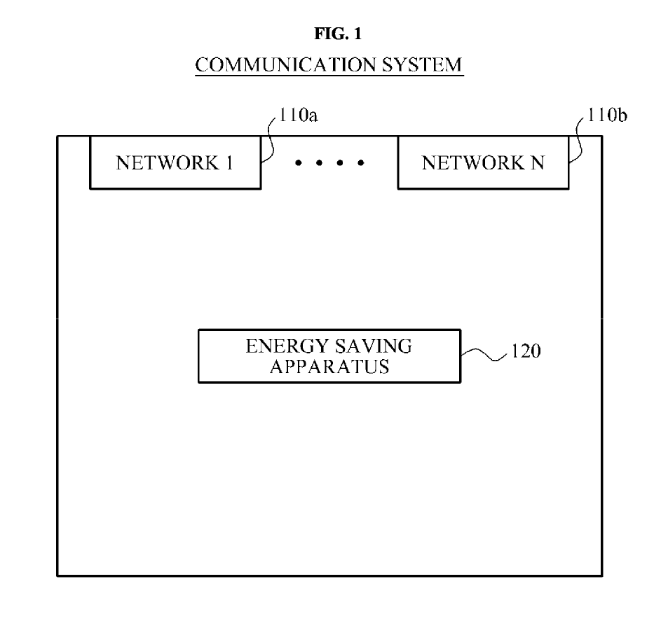

FIG. 1 is a diagram illustrating an apparatus for saving energy in a communication system supporting multiple interfaces according to an embodiment of the present invention. FIG. 1 illustrates an energy saving apparatus 120 of a communication system that may support heterogeneous networks 110a through 110b and use a service through the networks 110a through 110b.

The communication system may support multiple interfaces to enable use of various types of networks, for example, a third generation (3G) network, a wireless-fidelity (Wi-Fi) network, a Zigbee network, a Bluetooth network, a wireless local area network (WLAN), a femtocell network, a wireless broadband (WiBro) network, and the like. The energy saving apparatus 120 may be applied to a communication system supporting at least two different communication networks 110a and 110b.

The communication system may select an optimal communication network, in view of a characteristic of a service provided using the communication networks 110a and 110b, and other factors. In this example, the service refers to all services for downloading data from an upper system to the communication system, for example, a file transfer protocol (FTP) service, a live streaming service, a web service, and the like.

For each access technology, energy consumption according to a data rate may increase in a form of a convex function, and also in a form of a linear function. There may be various energy consumption patterns. Accordingly, an efficient access network may be changed based on a size of traffic, in terms of energy. In addition, when an interface switches a state mode from an idle mode (for example, when traffic is absent) to an active mode (for example, when traffic enters), or from the active mode to the idle mode, a considerable energy consumption overhead may occur. Accordingly, in order to distribute a data rate or select an interface, optimization may be performed based on an energy efficiency with respect to overhead, in consideration of whether the interface is currently in the idle mode or the active mode. In an actual case, while the WLAN may have an overload energy value when a state of energy is changed, the WLAN may have a relatively low rate of increase in energy consumption according to a data rate. Conversely, while the 3G network may have a relatively low overload energy value when a state of energy is changed, the 3D network may have a relatively high rate of increase in energy consumption according to a data rate. Accordingly, optimal distribution of energy may be performed based on an amount of entering traffic, and whether a state of energy of each interface corresponds to the idle mode or the active mode.

An amount of energy consumed for each interface may vary depending on a size of data when using a service, and furthermore, an amount of energy consumed when a state of energy of each interface is switched may vary for each interface. Accordingly, the energy saving apparatus 120 may select an interface optimal for energy consumption based on a current state of energy of each interface and a size of data when using the service, in order to reduce an amount of energy to be consumed by a terminal supporting multiple interfaces.

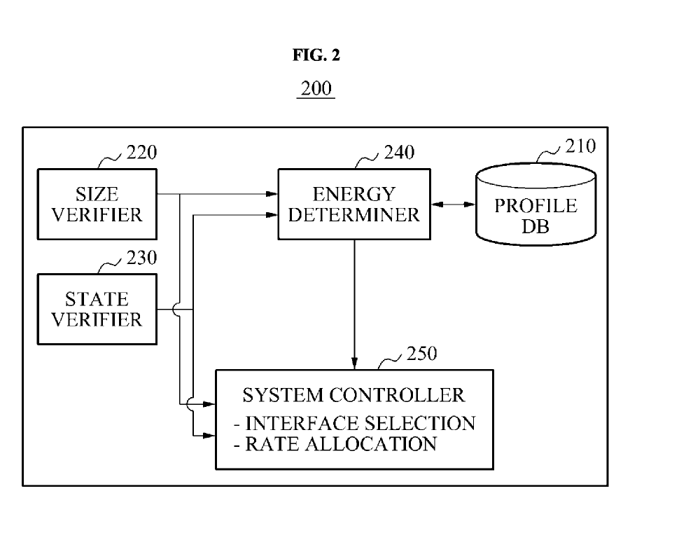

FIG. 2 is a block diagram illustrating a configuration of an energy saving apparatus for assigning a data rate by combining optimal interfaces in view of a size of data and a state of energy of an interface according to an embodiment of the present invention. Referring to FIG. 2, an energy saving apparatus 200 may include a profile database (DB) 210, a size verifier 220, a state verifier 230, an energy determiner 240, and a system controller 250.

The profile DB 210 may maintain profile information related to an amount of power to be consumed for each interface. Here, the profile information refers to information based on which an amount of energy consumed by a communication system is measured. For example, the profile database 210 may store a unit processing speed and a unit power predefined for each interface, as basis information to be used for determining an amount of energy expected to be consumed for downloading data, based on a size of the data. In addition, the profile database 210 may store, for each interface, a predefined amount of overload energy occurring when a state mode is switched from an idle mode to an active mode, or from the active mode to the idle mode. In particular, information to be used for determining overhead power expected when a state mode associated with a presence and absence of traffic is switched and an amount of energy expected to be consumed for downloading data based on a size of the data may be predefined and stored in the profile database 210 with respect to each interface.

The size verifier 220 may verify a size of data to be downloaded. The size verifier 220 may request the size of the data to be downloaded directly from an upper system providing a service, or determine the size of the data based on a history related to downloading.

The state verifier 230 may verify a state of energy for each interface, based on a current presence and absence of traffic, with respect to all interfaces supported by the communication system. In particular, the state verifier 230 may verify whether each interface is currently in an idle mode or an active mode.

The energy determiner 240 may determine, for each interface, an amount of overload energy expected to occur when a state mode associated with a presence and absence of traffic is switched, and an amount of energy expected to be consumed for downloading data, based on a size of the data to be downloaded based on the profile information. As an example, the energy determiner 240 may calculate, for each interface, an amount of energy to be consumed, in reality, for downloading data, based on the size of the data, a unit processing speed, and a unit power supported for each interface.

For example, the communication system may include interfaces corresponding to WLAN and 3G, the WLAN interface may have a unit processing speed of 0.2 megabits per second (Mbps) and a unit power of 500 milliwatts per second (mW/sec), and the 3D interface may have a unit processing speed of 0.5 Mbps and a unit power of 1000 mW/sec.

When a size of data corresponds to 2 megabytes (MB), the energy determiner 240 may calculate, for the WLAN interface, a download time of 10 seconds (sec) based on the size of the data corresponding to 2 MB and the unit processing speed of the WLAN interface corresponding to 0.2 Mbps, and calculate an amount of energy expected to be consumed for downloading the data through the WLAN interface, based on the calculated download time corresponding to 10 sec and the unit power of the WLAN interface corresponding to 500 mW/sec, that is, 10 sec×500 mW/sec=5000 mW. Also, the energy determiner 240 may calculate, for the 3G interface, a download time of 4 sec based on the size of the data corresponding to 2 MB and the unit processing speed of the 3G interface corresponding to 0.5 Mbps, and calculate an amount of energy expected to be consumed for downloading the data through the 3G interface, based on the calculated download time corresponding to 4 sec and the unit power of the 3G interface corresponding to 1000 mW/sec, that is, 4 sec×1000 mW/sec=4000 mW.

Since an interface to be used for downloading the data is to be in an active state, the energy determiner 240 may determine, for every interface currently in an idle mode, an amount of overload energy for each interface, by reading an amount of overload energy occurring when the state mode is switched from an idle mode to the active mode from the profile information stored in the profile database 210. Since an interface currently in the active mode may not need to switch the state mode, the energy determiner 240 may regard an amount of overload energy occurring when the state mode is switched from the idle mode to the active mode to be “0 (zero)”.

The system controller 250 may select at least one interface (hereinafter, referred to as “final interface”) to be used, in reality, for downloading the data, based on the amount of overload energy and the amount of energy to be consumed for each interface. The system controller 250 may select an optimal interface within a range satisfying a proper quality of service (QoS), based on both the amount of overload energy and the amount of energy to be consumed for each interface.

As an example, the system controller 250 may select interfaces, each having a total amount of energy less than or equal to a predetermined value, and select the final interface according to a priority determined based on a QoS defined in the communication system, from the selected interfaces. Here, the total amount of energy may be obtained by adding the amount of overload energy and the amount of energy to be consumed. In this instance, the predetermined value refers to a threshold value of energy guaranteeing a range satisfying the QoS defined in the communication system. An interface having the total amount of energy exceeding the predetermined value may not guarantee the proper QoS and thus, such an interface may be excluded from the selection of an interface to be used for downloading.

As another example, the system controller 250 may select interfaces, each having a total amount of energy less than or equal to a predetermined value, and select, from the selected interfaces, an interface having a download speed greater than or equal to a predetermined speed S as the final interface. Here, the total amount of energy may be obtained by adding the amount of overload energy and the amount of energy to be consumed. The predetermined speed S refers to a minimum download speed satisfying the QoS defined in the communication system. As a configuration therefor, the energy determiner 240 may calculate, for each of the selected interfaces, a download speed expected for downloading the data. In this instance, the download speed may be calculated based on a unit processing speed predefined for each interface. By means of the configuration, the system controller 250 may select, among the interfaces each having the total amount of energy less than or equal to the predetermined value, an interface guaranteeing a download speed satisfying the QoS defined in the communication system as the final interface.

As still another example, the system controller 250 may select interfaces, each having a total amount of energy less than or equal to a predetermined value, and select, among the selected interfaces, an interface having a download time less than or equal to a predetermined time R as the final interface. Here, the total amount of energy may be obtained by adding the amount of overload energy and the amount of energy to be consumed. The predetermined time R refers to a threshold value of a download time satisfying the QoS defined in the communication system. As a configuration therefor, the energy determiner 240 may calculate, for each of the selected interfaces, a download time expected for downloading data. In this instance, the energy determiner 240 may calculate the download time based on a size of the data and a unit processing speed predefined for each interface. By means of the configuration, the system controller 250 may select, among the interfaces each having the total amount of energy less than or equal to the predetermined value, an interface guaranteeing a download time satisfying the QoS defined in the communication system as the final interface.

As yet another example, the system controller 250 may select interfaces, each having a total amount of energy less than or equal to a predetermined value, and select, among the selected interfaces, an optimal interface based on a size of data to be downloaded. Here, the total amount of energy may be obtained by adding the amount of overload energy and the amount of energy to be consumed. Since an amount of load may vary greatly for each interface depending on the size of the data, the final interface to be used for downloading the data may be selected based on the size of the data. As a configuration therefor, the energy determiner 240 may calculate a download speed and a download time expected for downloading the data. By means of the configuration, the system controller 250 may select, among the interfaces each having the total amount of energy less than or equal to the predetermined value, an interface having a lowest total amount of energy, or an interface having a download speed greater than or equal to a predetermined speed S, since an amount of time to be consumed for downloading data of which a size is less than a predetermined size M may not be great, irrespective of an access end to be used. Here, the predetermined size M refers to a maximum size of data for which a download time to be consumed for downloading the data may not need to be considered. In addition, since a download time may vary greatly depending on an interface when the size of the data is greater than or equal to the predetermined size M, the system controller 250 may select an interface based on the download time, rather than the download speed. The system controller 250 may select, among the interfaces each having the total amount of energy less than or equal to the predetermined value, an interface having a download time less than or equal to a predetermined time R.

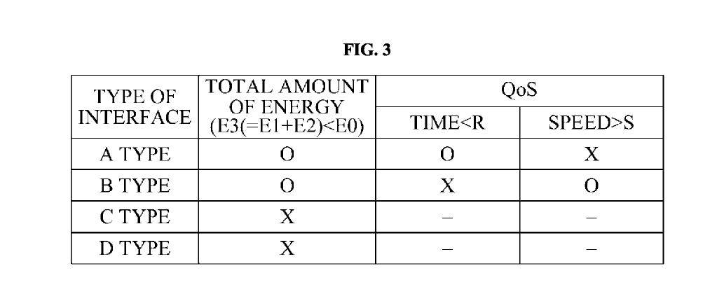

When multiple heterogeneous interfaces are used in the communication system, the energy saving apparatus 200 may select an optimal interface consuming relatively less energy, by comparing an amount of energy to be consumed for each interface. FIG. 3 is a table illustrating references for selecting an interface to optimize energy consumption according to an embodiment of the present invention. The energy saving apparatus 200 may primarily select interfaces, each having a total amount of energy E3 expected for each interface less than or equal to a predetermined value E0, as interfaces to be used for downloading data, and select, among the selected interfaces, an interface having a download time less than or equal to a predetermined time R, or an interface having a download speed greater than or equal to a predetermined speed S, as a final interface. Here, the total amount of energy E3 may be expressed by E3=E1+E2, wherein E1 denotes an amount of energy expected to be consumed for downloading data based on a size of the data, and E2 denotes an amount of overload energy expected to occur when a state mode associated with a presence and absence of traffic is switched. Referring to FIG. 3, in a communication system supporting interfaces of types A, B, C, and D, the interfaces “A” and “B”, each having the total amount of energy E3 less than or equal to the predetermined value E0, are distinct from the interfaces “C” and “D”, each having the total amount of energy E3 exceeding the predetermined value E0. In addition, FIG. 3 shows that the interface “A” has a download time less than or equal to the predetermined time R, and the interface “B” has a download speed greater than or equal to the predetermined speed S. In this example, the energy saving apparatus 200 may primarily select the interfaces “A” and “B” as interfaces to be used for downloading data, and select the interface “A” as the final interface when a priority is determined based on the download time or select the interface “B” as the final interface when a priority is determined based on the download speed.

Accordingly, the system controller 250 may select the optimal interface within the range satisfying the QoS defined in the communication system, based on both a state of energy of an interface and a size of the data, and may assign a data rate by combining at least one interface selected based on optimized conditions to distribute traffic for downloading the data. The system controller 250 may select the final interface to aggregate bandwidths by minimizing energy consumption, and distribute the traffic based on a data rate proper for each interface. As an example, the system controller 250 may assign a single stream U to be distributed to a plurality of interfaces k based on a proper data rate Uₖ to download the single stream U. Since the data rate Uₖ denotes a data rate at which data flows into the interfaces k, the data rate Uₖ may be greater than or equal to “0”, and may not exceed each interface capacity Cₖ. In addition, a minimum data rate r^{min} is to be guaranteed to guarantee a service.

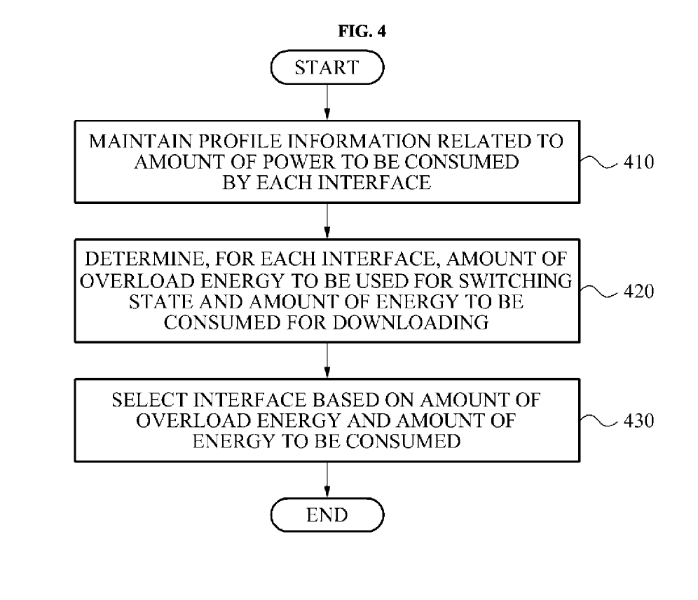

FIG. 4 is a flowchart illustrating an energy saving method for assigning a data rate by combining optimal interfaces in view of a size of data and a state of energy of an interface according to an embodiment of the present invention. The energy saving method according to the present embodiment may be performed by the energy saving apparatus 200 of FIG. 2.

In operation 410, profile information related to an amount of power to be consumed for each interface may be maintained. The energy saving apparatus 200 may maintain, in a database, a unit processing speed and a unit power predefined for each interface, as basis information to be used for determining an amount of energy expected to be consumed for downloading data, based on a size of the data. In addition, the energy saving apparatus 200 may maintain, in the database for each interface, a predefined amount of overload energy occurring when a state mode is switched from an idle mode to an active mode, or from the active mode to the idle mode.

In operation 420, an amount of overload energy E2 expected to occur when a state mode associated with a presence and absence of traffic is switched, and an amount of energy E1 expected to be consumed for downloading data, based on a size of the data to be downloaded may be determined for each interface based on the profile information. In this instance, the energy saving apparatus 200 may calculate the amount of energy E1 to be consumed in reality for downloading data, based on the size of the data, a unit processing speed, and a unit power. In addition, the energy saving apparatus 200 may determine, for every interface currently in an idle mode, an amount of overload energy E2 for each interface, by reading an amount of overload energy occurring when the state mode is switched from an idle mode to the active mode from the profile information stored in the database. Here, in a case of an interface currently in the active mode, the amount of overload energy E2 occurring when the state mode is switched from the idle mode to the active mode may be determined to be “0 (zero)”.

In operation 430, at least one interface, also referred to as final interfaces, to be used in reality for downloading the data may be selected based on the amount of overload energy E2 and the amount of energy E1 to be consumed for each interface. In this example, the energy saving apparatus 200 may select an optimal interface based on both a state of energy for each interface and a size of the data.

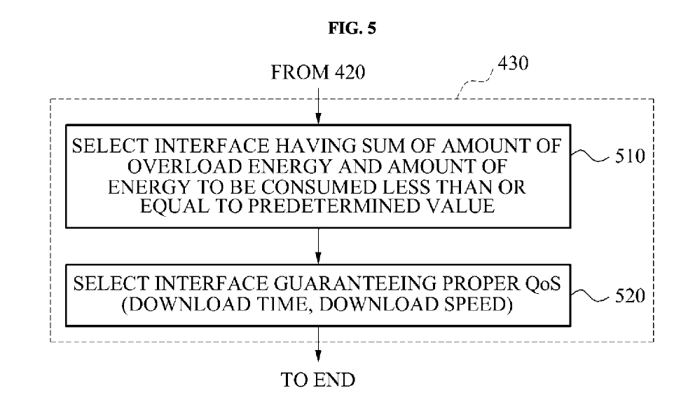

Operation 430 of selecting the final interface will be described in detail with reference to FIG. 5.

FIG. 5 is a flowchart illustrating an example of an operation of selecting an optimal interface within a range satisfying a proper QoS according to an embodiment of the present invention. The energy saving method according to the present embodiment may be performed by the energy saving apparatus 200 of FIG. 2.

In operation 510, interfaces, each having a total amount of energy E3 less than or equal to a predetermined value E0, may be selected. Here, the total amount of energy E3 may be obtained by adding an amount of overload energy E2 and an amount of energy E1 to be consumed. The predetermined value E0 refers to a threshold value of energy satisfying a QoS defined in a communication system. An interface having the total amount of energy E3 exceeding the predetermined value E0 may not guarantee a proper QoS and thus, such an interface may be excluded from the selection of an interface to be used for downloading.

In operation 520, a final interface may be selected from the interfaces selected in operation 510, based on a priority determined based on the QoS defined in the communication system. As an example, the energy saving apparatus 200 may select, among the interfaces selected in operation 510, an interface having a download speed greater than or equal to a predetermined speed S as the final interface. The predetermined speed S refers to a minimum download speed satisfying the QoS defined in the communication system. As another example, the energy saving apparatus 100 may select, among the interfaces selected in operation 510, an interface having a download time less than or equal to a predetermined time R as the final interface. The predetermined time R refers to a threshold value of a download time satisfying the QoS defined in the communication system.

As described above, according to embodiments of the present invention, in order to reduce energy consumption in a communication system supporting multiple interfaces, a size of data and a state of energy of each interface may be considered. In particular, an amount of energy to be consumed may verify depending on a size of data to be downloaded, and each interface may have a different energy consumption pattern. Accordingly, an optimal interface may be determined based on such factors. In addition, an amount of overhead energy to occur when a state of energy of each interface is switched may vary for each interface and thus, an interface may be determined based on a current state of energy of each interface. Efficient resource distribution in terms of energy may be implemented through technologies for selecting an interface that may guaranteeing a proper QoS in a terminal supporting multiple interfaces while optimizing battery consumption.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for saving energy in a communication system supporting network-based multiple interfaces, the apparatus comprising:
a profile database to maintain profile information related to an amount of power to be consumed for each interface;
an energy determiner to determine, for each interface, an amount of overload energy expected to occur when a state mode associated with a presence and absence of traffic is switched, and an amount of energy expected to be consumed for downloading data, based on a size of the data to be downloaded using the profile information; and
a system controller to select at least one interface to be used for downloading the data, based on the amount of overload energy and the amount of energy to be consumed.

2. The apparatus of claim 1, wherein the system controller selects the at least one interface according to a priority determined based on a quality of service (QoS) defined in the communication system, from interfaces, each having a total amount of energy less than or equal to a predetermined value,
wherein the total amount of energy is obtained by adding the amount of overload energy to the amount of energy to be consumed.

3. The apparatus of claim 1, wherein:
the energy determiner calculates, for each interface, a download time expected for downloading the data, and
the system controller selects an interface having the expected download time less than or equal to a predetermined amount of time, from interfaces, each having a total amount of energy less than or equal to a predetermined value,
wherein the total amount of energy is obtained by adding the amount of overload energy to the amount of energy to be consumed.

4. The apparatus of claim 1, wherein:
the energy determiner calculates, for each interface, a download speed expected for downloading the data, and
the system controller selects an interface having the expected download speed greater than or equal to a predetermined speed, from interfaces, each having a total amount of energy less than or equal to a predetermined value,
wherein the total amount of energy is obtained by adding the amount of overload energy to the amount of energy to be consumed.

5. The apparatus of claim 1, wherein:
the energy determiner calculates, for each interface, a download speed expected for downloading the data, and
the system controller selects an interface having the expected download speed greater than or equal to a predetermined value, from interfaces, each having a total amount of energy less than or equal to a predetermined value, when the size of the data is less than a predetermined size,
wherein the total amount of energy is obtained by adding the amount of overload energy to the amount of energy to be consumed.

6. The apparatus of claim 5, wherein:
the energy determiner calculates, for each interface, a download time expected for downloading the data, and
the system controller selects an interface having the expected download time less than or equal to a predetermined amount of time, from interfaces, each having a total amount of energy less than or equal to a predetermined value, when the size of the data is greater than or equal to the predetermined size,
wherein the total amount of energy is obtained by adding the amount of overload energy to the amount of energy to be consumed.

7. The apparatus of claim 1, wherein the system controller distributes a data rate for the downloading with respect to the at least one interface.

8. A method of saving energy in a communication system supporting network-based multiple interfaces, the method comprising:
maintaining profile information related to an amount of power to be consumed for each interface;
determining, for each interface, an amount of overload energy expected to occur when a state mode associated with a presence and absence of traffic is switched, and an amount of energy expected to be consumed for downloading data, based on a size of the data to be downloaded using the profile information; and
selecting at least one interface to be used for downloading the data, based on the amount of overload energy and the amount of energy to be consumed.

9. The method of claim 8, wherein the selecting comprises selecting the at least one interface according to a priority determined based on a quality of service (QoS) defined in the communication system, from interfaces, each having a total amount of energy less than or equal to a predetermined value,
wherein the total amount of energy is obtained by adding the amount of overload energy to the amount of energy to be consumed.

10. The method of claim 8, wherein:
the determining comprises calculating, for each interface, a download time expected for downloading the data, and
the selecting comprises selecting an interface having the expected download time less than or equal to a predetermined amount of time, from interfaces, each having a total amount of energy less than or equal to a predetermined value,
wherein the total amount of energy is obtained by adding the amount of overload energy to the amount of energy to be consumed.

11. The method of claim 8, wherein:
the determining comprises calculating, for each interface, a download speed expected for downloading the data, and
the selecting comprises selecting an interface having the expected download speed greater than or equal to a predetermined speed, from interfaces, each having a total amount of energy less than or equal to a predetermined value,
wherein the total amount of energy is obtained by adding the amount of overload energy to the amount of energy to be consumed.

12. The method of claim 8, wherein:
the determining comprises calculating, for each interface, a download speed expected for downloading the data, and
the selecting comprises selecting an interface having the expected download speed greater than or equal to a predetermined value, from interfaces, each having a total amount of energy less than or equal to a predetermined value, when the size of the data is less than a predetermined size,
wherein the total amount of energy is obtained by adding the amount of overload energy to the amount of energy to be consumed.

13. The method of claim 12, wherein:
the determining comprises calculating, for each interface, a download time expected for downloading the data, and
the selecting comprises selecting an interface having the expected download time less than or equal to a predetermined amount of time, from interfaces, each having a total amount of energy less than or equal to a predetermined value, when the size of the data is greater than or equal to the predetermined size,
wherein the total amount of energy is obtained by adding the amount of overload energy to the amount of energy to be consumed.

14. The method of claim 8, wherein the selecting comprises distributing a data rate for the downloading with respect to the at least one interface.
